(19) United States
(12) Patent Application Publication
(10) Pub. No.: US 2026/0231850 A1
(43) Pub. Date: Aug. 13, 2026

(54) AGRICULTURAL SEED METER AND RELATED DEVICES, SYSTEMS, AND METHODS

(71) Applicant: Ag Leader Technology, Ames, IA (US)

(72) Inventor: Alan F. Barry, Nevada, IA (US)

(21) Appl. No.: 19/537,260

(22) Filed: Feb. 11, 2026

Related U.S. Application Data
(60) Provisional application No. 63/757,242, filed on Feb. 11, 2025.

(51) Int. Cl. A01C 7/04; A01C 7/10

(52) U.S. Cl. CPC A01C 7/0445; A01C 7/0443; A01C 7/105

(57) ABSTRACT

An agricultural seed meter system including a seed meter, a gravity type seed delivery tube, an adaptor configured to connect the seed meter and the gravity type seed delivery tube, a positive air flow source directed to a seed discharge point on the seed meter configured to accelerate a seed away from a seed disc and into the gravity type seed delivery tube, and a crowder brush disposed at or near the seed discharge point. The system allows high speed seed meters to be used with conventional gravity drop type seed tubes while maintaining population, spacing, and precision needs of high speed planting.

### CROSS-REFERENCE TO RELATED APPLICATION(S)

This application claims the benefit under 35 U.S.C. § 119(e) to U.S. Provisional Application 63/757,242, filed Feb. 11, 2025, and entitled Seed Meter, which is hereby incorporated herein by reference in its entirety for all purposes.

### TECHNICAL FIELD

The disclosure relates to agricultural seed meters, and related devices, systems, and methods.

### BACKGROUND

The disclosure relates to agricultural seed meters and in particular to gravity drop type seed meters.

### BRIEF SUMMARY

Disclosed herein are various agricultural seed meters and particularly seed meters for planting row crops. Various of the seed meters disclosed herein relate to improvements to conventional gravity drop type seed meters.

In Example 1, an agricultural seed meter comprising a seed meter, a gravity type seed delivery tube, an adaptor configured to connect the seed meter and the gravity type seed delivery tube, a positive air flow source directed to a seed discharge point on the seed meter configured to accelerate a seed away from a seed disc and into the gravity type seed delivery tube, and a crowder brush disposed at or near the seed discharge point.

Example 2 relates to the agricultural seed meter of any of Examples 1 and 3-9, wherein the adaptor comprises a drop tube adaptor having one or more vent holes configured to vent air from the positive air flow source.

Example 3 relates to the agricultural seed meter of any of Examples 1-2 and 4-9, wherein the adaptor is made of a material configured to dampen bounce back of a seed striking an inner wall of the adaptor.

Example 4 relates to the agricultural seed meter of any of Examples 1-3 and 5-9, further comprising an ejector wheel configured to lift seed off the seed disc to break a vacuum holding the seed to the seed disc.

Example 5 relates to the agricultural seed meter of any of Examples 1-4 and 6-9, wherein the ejector wheel comprises one or more arms configured to extend through apertures in the seed disc.

Example 6 relates to the agricultural seed meter of any of Examples 1-5 and 7-9, further comprising one or more air flow deflector brushes positioned to direct air flow and limit seed deflection.

Example 7 relates to the agricultural seed meter of any of Examples 1-6 and 8-9, wherein the positive air flow source is configured to accelerate the seed to change direction from a horizontal tangent to a vertical tangent.

Example 8 relates to the agricultural seed meter of any of Examples 1-7 and 9, wherein the crowder brush is configured to orient seeds against an inner housing wall of the seed meter.

Example 9 relates to the agricultural seed meter of any of Examples 1-8, wherein the positive air flow source comprises an air supply tube shaped and oriented to blow air at an area of the seed meter near and in a direction of seed discharge.

In Example 10, a seed delivery system for an agricultural planter, the system comprising a seed meter having a rotatable seed disc configured to singulate seeds, a gravity type seed tube configured to deliver seeds to a furrow, a drop tube adaptor configured to connect the seed meter and the gravity type seed tube, a positive air flow source directed at a seed discharge point on the seed meter, the positive air flow source configured to accelerate seeds away from the seed disc and into the drop tube adaptor, and a crowder brush disposed at or near the seed discharge point configured to orient seeds against an inner housing wall of the seed meter.

Example 11 relates to the seed delivery system of any of claims 10 and 12-16, wherein the drop tube adaptor comprises one or more vent holes.

Example 12 relates to the seed delivery system of any of claims 10-11 and 13-16, further comprising one or more air flow deflector brushes positioned to direct air flow and limit seed deflection.

Example 13 relates to the seed delivery system of any of claims 10-12 and 14-16, wherein the crowder brush is configured to orient seeds against an inner housing wall of the seed meter.

Example 14 relates to the seed delivery system of any of claims 10-13 and 15-16, further comprising an ejector wheel comprising one or more arms configured to extend through apertures in the seed disc.

Example 15 relates to the seed delivery system of any of claims 10-14 and 16, wherein the positive air flow source comprises an air supply tube.

Example 16 relates to the seed delivery system of any of claims 10-15, wherein the positive air flow source is configured to accelerate the seed to change direction from a horizontal tangent to a vertical tangent.

In Example 17, a method of delivering seeds in an agricultural planter, the method comprising: singulating seeds using a seed meter having a rotatable seed disc; breaking a vacuum holding a seed to the seed disc using an ejector wheel; directing positive air flow at a seed discharge point on the seed meter to accelerate the seed away from the seed disc; orienting seeds against an inner housing wall of the seed meter using a crowder brush; and delivering the seed through an adaptor and a gravity type seed tube to a furrow.

Example 18 relates to the method of any of claims 17 and 19-20, further comprising venting air from the positive air flow through one or more vent holes in the adaptor connecting the seed meter and the gravity type seed tube.

Example 19 relates to the method of any of claims 17-18 and 20, wherein directing positive air flow comprises changing a direction of the seed from a horizontal tangent due to rotation of the seed disc to a vertical tangent into the gravity type seed tube.

Example 20 relates to the method of any of claims 17-19, further comprising controlling a speed of the positive air flow to provide ground speed compensation.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a perspective view of a planter, according to one implementation.

FIG. 2 is a perspective view of a planter row unit, according to one implementation.

FIG. 3 is an internal view of a seed meter, according to one implementation.

FIG. 4A is an isolated view of an air supply, according to one implementation.

FIG. 4B is a perspective view of a row unit showing an air supply hose, according to one implementation.

FIG. 5 is an internal view of a seed meter with ejector wheel, according to one implementation.

FIG. 6 is an isolated view of exemplary ejector wheels, according to one implementation.

FIG. 7A shows an ejector wheel in use with a seed disc, according to one implementation.

FIG. 7B shows an ejector wheel in use with a seed disc, according to one implementation.

FIG. 8 in an internal view of a seed meter and seed drop area, according to one implementation.

FIG. 9 is a perspective view of a seed tube adaptor connecting the meter and the seed tube, according to one implementation.

FIG. 10 is a perspective view of the adaptor in place on a row unit, according to one implementation.

FIG. 11 is a close up view of the adaptor in place on a row unit, according to one implementation.

### DETAILED DESCRIPTION

Disclosed herein is a seed meter system including a drop extension shaped and arranged for connecting a metering device with a drop tube, such that a gravity type seed tube, that can be used while allowing for high speed planting with precision.

Many high speed seed meters (such as Ag Leader® Surespeed®) utilize a mechanical belt seed tube. Disclosed herein is a seed meter with a drop extension added to the metering device that can be used with a conventional gravity drop type seed tube and sensor. That is, a high speed seed meter can be used in connection with a conventional gravity drop type seed tube while maintaining the population, spacing, and precision needs of high speed planting, which otherwise would not be possible.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. Patent Application Ser. No. 17/013,037, filed Sept. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. Pat. No. 12,353,210, issued Jul. 8, 2025, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. Pat. No. 12,268,115, issued Apr. 8, 2025, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. Pat. No. 12,414,505, issued Sep. 16, 2025, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/556,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. Pat. No. 12,403,950, issued Sep. 2, 2025, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/766,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices and Methods,” U.S. patent application Ser. No. 19/305,530, filed Aug. 20, 2025, entitled “Crop Sensor Wands and Related Devices, Systems, and Methods,” U.S. patent application Ser. No. 19/366,202, filed Oct. 22, 2025, entitled “Crop Sensors and Related Devices, Systems, and Methods,” U.S. patent application Ser. No. 19/367,363, filed Oct. 23, 2025, entitled “Agricultural Sprayer Sensor and Related Devices, Systems, and Methods,” U.S. patent application Ser. No. 19/390,280, filed Nov. 14, 2025, entitled “Liquid Product Distribution for Agricultural Spraying Systems and Related Devices and Methods,” U.S. patent application Ser. No. 19/396,047, filed Nov. 20, 2025, entitled “Agricultural Harvesting Systems and Related Devices and Methods,” U.S. patent application Ser. No. 19/396,099, filed Nov. 20, 2025, entitled “Sprayer Nozzle Devices and Related Systems and Methods,” U.S. patent application Ser. No. 19/397,422, filed Nov. 21, 2025, entitled “Systems, Methods, and Devices for Increasing Machine Operating Range,” U.S. patent application Ser. No. 19/408,177, filed Dec. 3, 2025, entitled “Agricultural Guidance and Navigation System and Related Devices and Methods,” U.S. patent application Ser. No. 19/467,539, filed Feb. 2, 2026, entitled “System and Automatic Adjustment to Target Pressure and Related Devices and Methods,” U.S. patent application Ser. No. 19/467,588, filed Feb. 2, 2026, entitled “Harvester Liquid Application System, Devices, and Methods,” U.S. patent application Ser. No. 19/468,722, filed Feb. 3, 2026, entitled “Agricultural Navigation Methods, Devices, and Systems,” U.S. patent application Ser. No. 19/468,873, filed Feb. 3, 2026, entitled “Agricultural Mapping and Related Devices, Systems, and Methods,” U.S. patent application Ser. No. 19/534,324, filed Feb. 9, 2026, entitled “Remote Assistance for Agricultural Display Methods and Related Devices and Systems,” U.S. patent application 63/757,434, filed Feb. 12, 2025, entitled “Grain Fill Sensor,” U.S. Patent Application 63/760,907, filed Feb. 20, 2025, entitled “Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” U.S. Patent Application 63/906,692, filed Oct. 28, 2025, entitled “Agricultural Alignment System and Related Devices and Methods,” U.S. Patent Application 63/906,646, filed Oct. 28, 2025, entitled “Automated Grail Filling System and Related Devices and Methods,” U.S. Patent Application 63/967,084, filed Jan. 23, 2025, entitled “System and Methods of Row-by-Row Yield Monitoring,” U.S. Patent Application 63/966,976, filed Jan. 23, 2025, entitled “Dispatch Indicator Calibration,” and U.S. Patent Application 63/967,038, filed Jan. 23, 2025, entitled “Grain Fill Sensor and Related Devices, Systems, and Methods,” each of which is incorporated herein by reference.

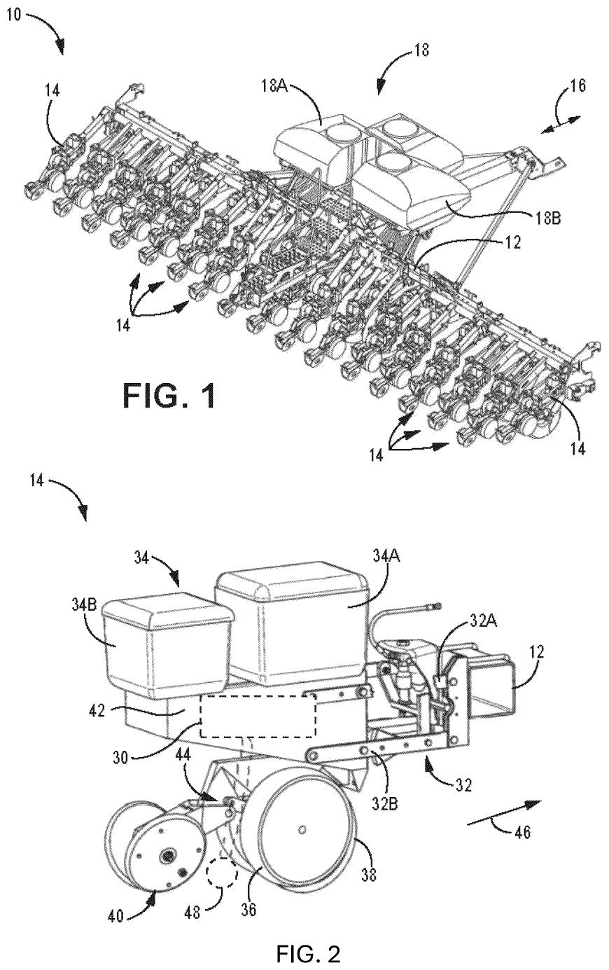

Turning to the figures in more detail, FIG. 1A depicts an exemplary planter or seeding machine 10 that, according to one implementation, can have a seed delivery system with a seed spacing device. The planting machine 10 in this specific implementation is a row crop planter 10 having a central crossbar 12 and multiple planting row units 14 mounted to the crossbar 12. At least one hopper (also referred to herein as a “storage tank”) 18 is disposed on the seeding machine 10 to hold seed and is fluidically coupled to unit hoppers (also referred to as “mini-hoppers”) (such as hopper 34 as discussed below) on each planting unit 14 such that seed can be delivered pneumatically from the hopper 18 to a unit hopper (such as hopper 34) on each unit 14. Alternatively, the planter 10 has two hoppers 18A, 18B as shown. In a further alternative, any known hopper or seed retention device configuration can be incorporated into the planter 10 and the separate units 14 and function with the seed delivery system implementations herein. It is understood that, generally, the row units 14 on a particular planter (such as exemplary planter 10) are typically identical or substantially similar. The seeding machine 10 moves forward and backward via the fore-aft direction shown by the arrow 16.

One example of a row unit 14 having a seed delivery system 40 with a seed spacing device 48, according to one implementation, is depicted in greater detail in FIG. 2. It is understood that any seed delivery and spacing system according to any implementation disclosed or contemplated herein (such as system 40 with spacing device 48) can be incorporated into any known row unit 14 having any configuration.

The particular exemplary row unit 14 is jointedly coupled to the central crossbar 12 via a parallelogram linkage 32 made up of two linkage arms 32A, 32B such that the individual units 14 are vertically moveable by a predetermined amount relative to the crossbar 12. The exemplary row unit 14 in this implementation has known components, including a seed meter 30, a hopper 34, gauge wheels 36 (controlling the depth of the furrow), furrow opening disks 38 (to form an open furrow in the soil beneath the seeding machine into which seed is deposited), and a closing and packing wheel (or wheels, in this specific example) 40 (to close the furrow over the deposited seed and to firm the soil in the closed furrow), as are generally understood in the art. Alternatively, any similar known components or features or additional known features or components can be incorporated into the row units 14.

According to certain implementations, the hopper 34 is made up of at least two hoppers 34A, 34B. For example, in one implementation, the hopper 34 is made up of one seed hopper 34A and a chemical hopper 34B, such that the seed hopper 34A contains seed and the chemical hopper 34B can contain a herbicide, insecticide, or any other known chemical for application while planting, including any combination thereof. Alternatively, any known combination of hoppers can be incorporated herein.

In this implementation, the seed metering system 30 is disposed on the row unit 14, and more specifically, coupled to, or disposed within, the frame member 42 thereof, such that it can be in operable communication with the hopper 34 and the seed delivery system 44. The frame member 42 is jointedly coupled to the parallelogram linkage 32. The seed is stored or retained in the seed hopper 34 and provided to the seed meter 30. In one implementation, the seed hopper 34 is coupled to the seed metering device 30 via a tubular connection, as would be appreciated. The seed meter system 30 singulates the seed and transfers it to the delivery system 44, which carries the seed into a planting furrow, or trench, formed in the soil by furrow opening disks 38. The crossbar 12 and row unit 14 are designed to be moved over the ground in a forward working direction identified by arrow 46.

Thus, it is understood that the various seed delivery and seed spacing implementations disclosed or contemplated herein can be incorporated into any known planters or planting systems, and further can be incorporated into each row unit therein.

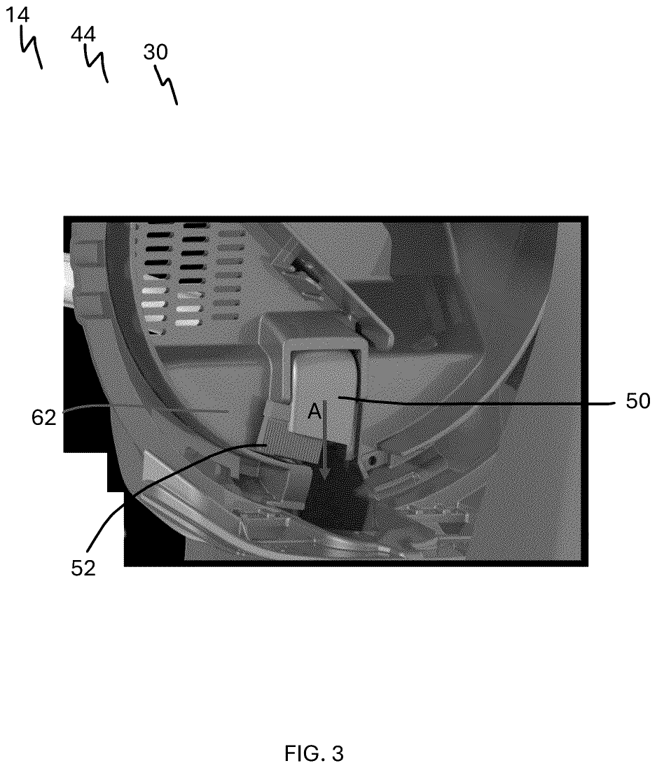

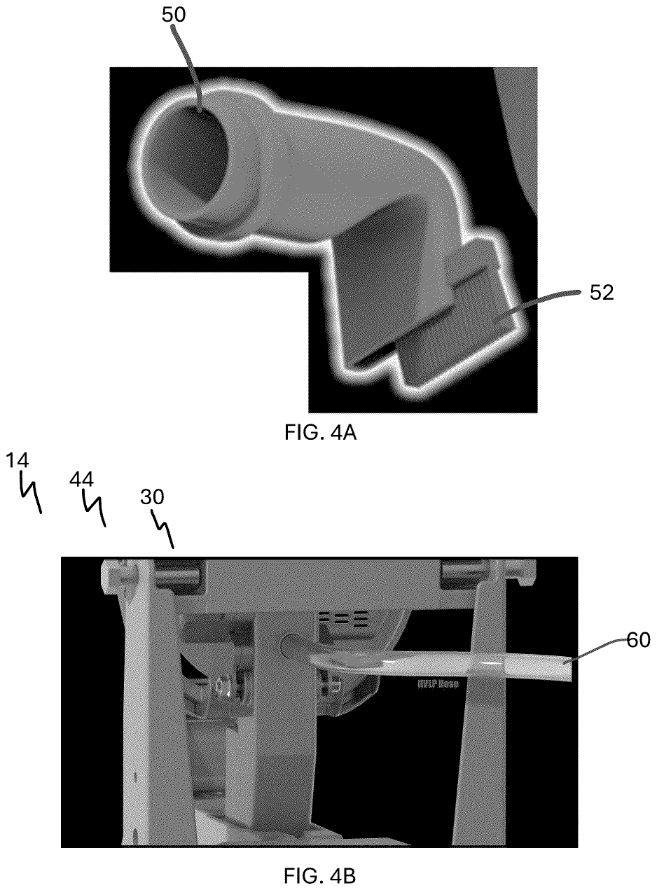

Turning to FIG. 3, in various implementations, positive air is blown (along arrow A) into the area of the seed meter 30/disc (not shown) where the seed will be discharged to be planted. FIG. 4A shows an isolated view of the air supply 50 and seed crowder brush 52, as will be discussed further herein. As can be seen, the air supply 50 tube is shaped and oriented to blow air at the area of the meter near and in the direction of discharge. FIG. 4B shows an exemplary air supply hose 60, which is in fluidic communication with the air supply 50 to supply positive pressure air to the system.

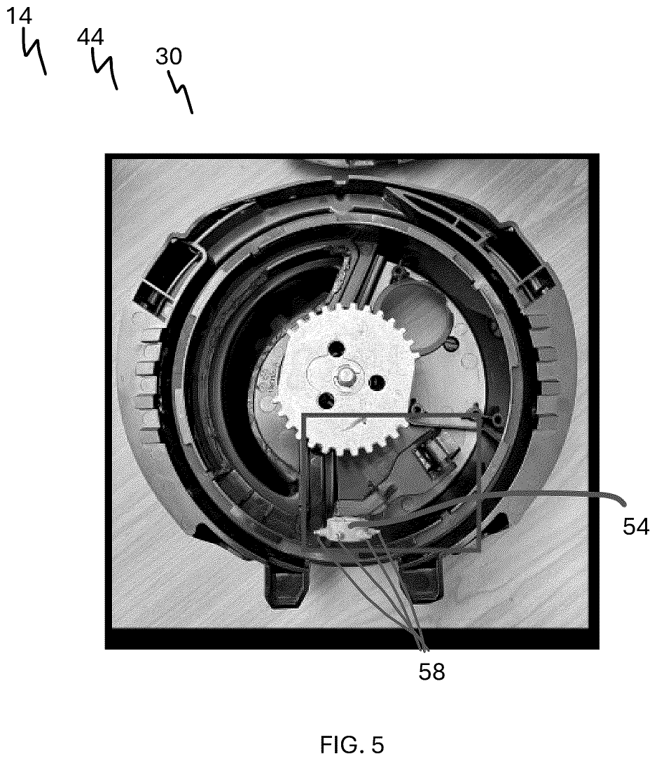

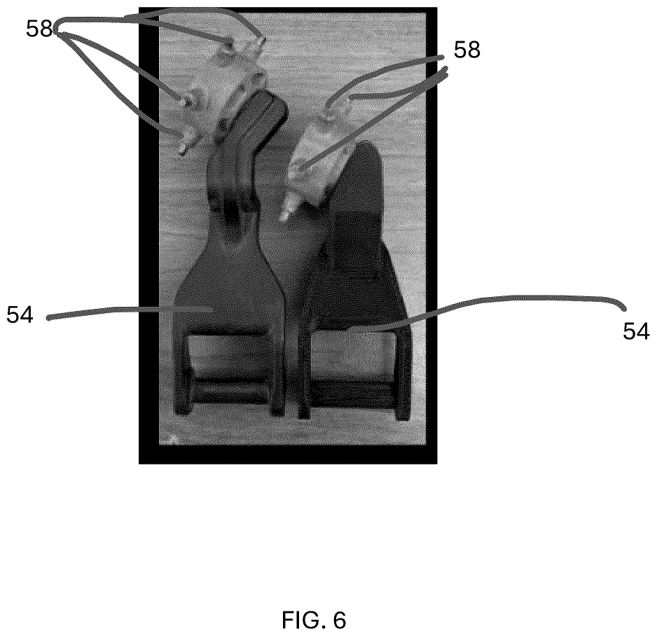

FIG. 5 shows an exemplary ejector wheel 54. The ejector wheel 54 is configured to lift the seed off the seed disc breaking the vacuum holding the seed to the disc allowing the positive air flow (described above) to carry the seed down through the drop extension and into the seed tube. In various implementations, the ejector wheel 54 has shorter arms 58, compared to an ejector wheel that would ordinarily be used in high speed planting with a belt type seed tube. FIG. 6 shows two exemplary ejector wheels 54 separated from a seed meter 30.

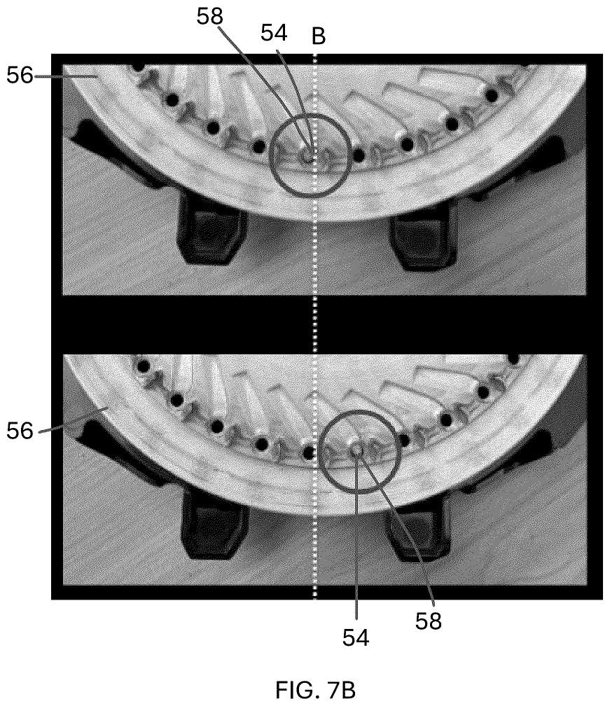

FIGS. 7A and 7B show the ejector wheel 54 in use with the seed disc 56. As can be seen, the ejector wheel 54 arm 58 extends through an aperture in the seed disc 56, where the seed are held, to break the vacuum holding the seed.

The positive air pressure and flow accelerate the seed away from the seed disc and cause the seed to change direction from a horizontal tangent because of the rotation of the disc to a vertical tangent because of the direction and force of the airflow from the air supply 50. The seed and air discharge at the lower end of the seed tube cause the seed to land in the furrow with some rearward trajectory because of the curvature of the seed tube. The fall rate of the seed will be a combination of the air speed that accelerates the seed away from the seed disc (via the air supply 50) and the effect of gravity.

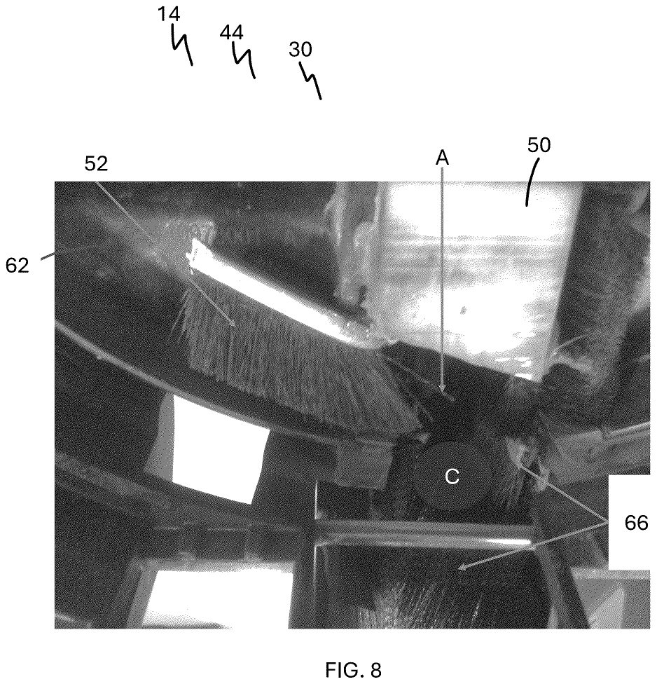

In various implementations, a crowder brush 52, shown variously in FIGS. 3, 4, and 8, orients the seeds against an inner housing wall 62 of the seed meter 30 such that all the seeds start to fall from the same position as they reach the drop point (point C). Various implementation may also include one or more air flow deflector brushes 66 positioned to direct air flow and limit seed deflection.

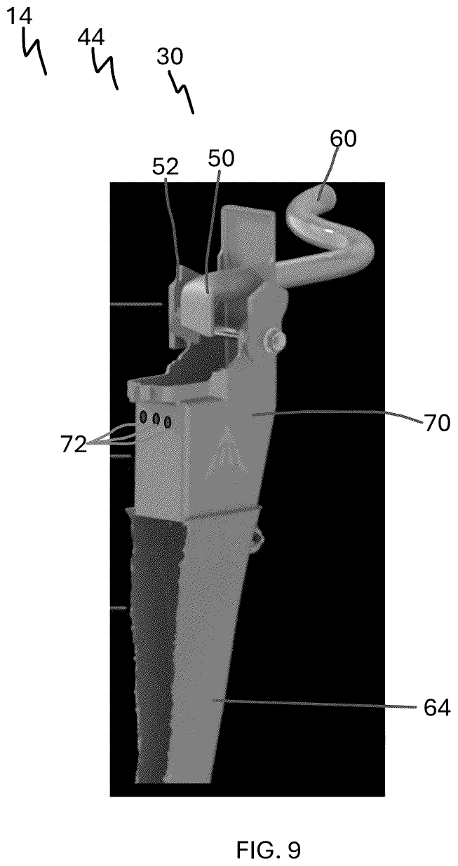

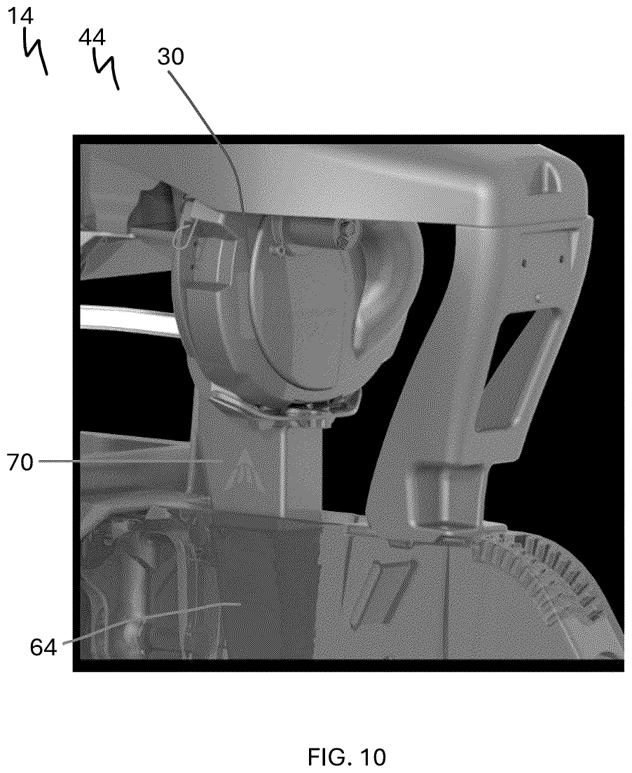

Turning now to FIGS. 9 and 10, in various implementations, the system includes a drop tube adaptor 70 in fluidic communication with the meter 30 and the seed tube 64. In various implementation, the drop tube adaptor 70 includes vent holes 72 to vent off air so the air flow is not limited by the volumetric size of the seed tube 64. Various seed tubes 64 have different cross-sectional areas and the air pressure from the air supply 50 is only needed to propel the seed away from the seed meter disk; gravity takes the seed to the furrow.

The adapter 70 may be made of a material or materials that dampen the bounce back of a seed that may strike the inner wall of the adaptor 70. Rather than ricochet off the inner wall the seed falls downward maintaining the seed spacing created by the removal of the seed from the seed disk.

Strip brushes 52, 66 located about the area of the seed disk drop point help direct airflow and help seeds fall to the center of the drop area C making a consistent exit path as the seed leaves the meter 30.

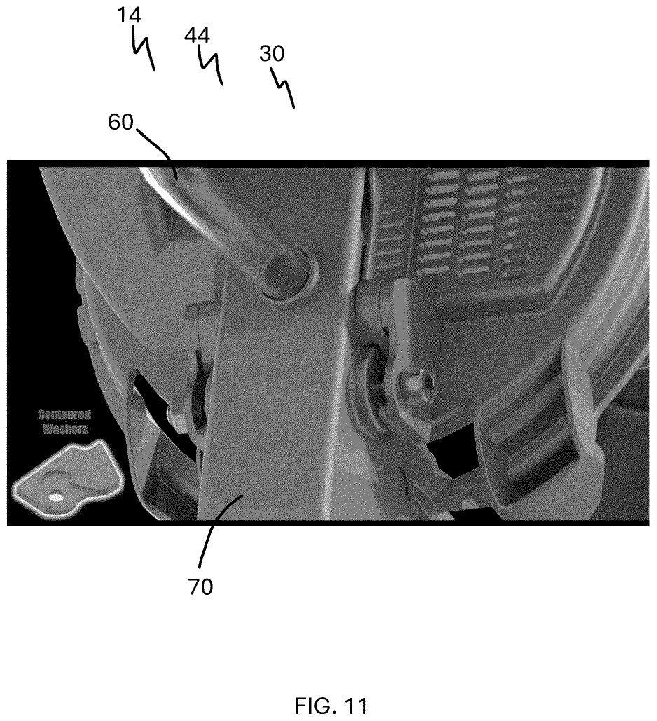

FIG. 11 shows a further view of the system installed on a row unit 14.

This is an improvement over conventional gravity drop type seed meters because the seed is urged to fall by the positive air pressure flow from the air supply 50. The effects of row unit 14 bounce will be minimized similar to current belt delivery type systems, while avoiding the excess parts and maintenance required by belt delivery type systems.

Additionally, there may be some ground speed compensation because the speed of the air flow can be controlled. This will result in acceptable seed spacing results over a wider range of ground speeds than conventional gravity drop systems. Because the customer can continue to use a conventional seed drop tube the cost to install this system will be reduced as compared to current high speed planting systems utilizing a mechanical belt delivery tube.

Further, downward air flow through the seed delivery tube will prevent dust from filtering into a seed sensor area causing inaccurate seed counts, as would be appreciated.

Additionally, there are no modifications made to the structure or function of the seed meter 30 so a customer could upgrade to a mechanical belt delivery tube style system at any time without needing to replace the seed meter 30 itself.

This concept will allow the customer to use a seed meter designed to operate with population and spacing precision at speeds up to about 12 MPH without the cost, complexity, and maintenance requirements of current high speed planting systems.

Although the disclosure has been described with references to various embodiments, persons skilled in the art will recognize that changes may be made in form and detail without departing from the spirit and scope of this disclosure.

What is claimed is:

1. An agricultural seed meter comprising:
(a) a seed meter;
(b) a gravity type seed delivery tube;
(c) an adaptor configured to connect the seed meter and the gravity type seed delivery tube;
(d) a positive air flow source directed to a seed discharge point on the seed meter configured to accelerate a seed away from a seed disc and into the gravity type seed delivery tube; and
(e) a crowder brush disposed at or near the seed discharge point.

2. The agricultural seed meter of claim 1, wherein the adaptor comprises a drop tube adaptor having one or more vent holes configured to vent air from the positive air flow source.

3. The agricultural seed meter of claim 1, wherein the adaptor is made of a material configured to dampen bounce back of a seed striking an inner wall of the adaptor.

4. The agricultural seed meter of claim 1, further comprising an ejector wheel configured to lift seed off the seed disc to break a vacuum holding the seed to the seed disc.

5. The agricultural seed meter of claim 4, wherein the ejector wheel comprises one or more arms configured to extend through apertures in the seed disc.

6. The agricultural seed meter of claim 1, further comprising one or more air flow deflector brushes positioned to direct air flow and limit seed deflection.

7. The agricultural seed meter of claim 1, wherein the positive air flow source is configured to accelerate the seed to change direction from a horizontal tangent to a vertical tangent.

8. The agricultural seed meter of claim 1, wherein the crowder brush is configured to orient seeds against an inner housing wall of the seed meter.

9. The agricultural seed meter of claim 1, wherein the positive air flow source comprises an air supply tube shaped and oriented to blow air at an area of the seed meter near and in a direction of seed discharge.

10. A seed delivery system for an agricultural planter, the system comprising:
(a) a seed meter having a rotatable seed disc configured to singulate seeds;
(b) a gravity type seed tube configured to deliver seeds to a furrow;
(c) a drop tube adaptor configured to connect the seed meter and the gravity type seed tube;
(d) a positive air flow source directed at a seed discharge point on the seed meter, the positive air flow source configured to accelerate seeds away from the seed disc and into the drop tube adaptor; and
(f) a crowder brush disposed at or near the seed discharge point configured to orient seeds against an inner housing wall of the seed meter.

11. The seed delivery system of claim 10, wherein the drop tube adaptor comprises one or more vent holes.

12. The seed delivery system of claim 10, further comprising one or more air flow deflector brushes positioned to direct air flow and limit seed deflection.

13. The seed delivery system of claim 10, wherein the crowder brush is configured to orient seeds against an inner housing wall of the seed meter.

14. The seed delivery system of claim 10, further comprising an ejector wheel comprising one or more arms configured to extend through apertures in the seed disc.

15. The seed delivery system of claim 10, wherein the positive air flow source comprises an air supply tube.

16. The seed delivery system of claim 10, wherein the positive air flow source is configured to accelerate the seed to change direction from a horizontal tangent to a vertical tangent.

17. A method of delivering seeds in an agricultural planter, the method comprising:
singulating seeds using a seed meter having a rotatable seed disc;
breaking a vacuum holding a seed to the seed disc using an ejector wheel;
directing positive air flow at a seed discharge point on the seed meter to accelerate the seed away from the seed disc;
orienting seeds against an inner housing wall of the seed meter using a crowder brush; and
delivering the seed through an adaptor and a gravity type seed tube to a furrow.

18. The method of claim 17, further comprising venting air from the positive air flow through one or more vent holes in the adaptor connecting the seed meter and the gravity type seed tube.

19. The method of claim 17, wherein directing positive air flow comprises changing a direction of the seed from a horizontal tangent due to rotation of the seed disc to a vertical tangent into the gravity type seed tube.

20. The method of claim 17, further comprising controlling a speed of the positive air flow to provide ground speed compensation.
